(19) United States
(12) Patent Application Publication
(10) Pub. No.: US 2002/0043806 A1
(43) Pub. Date: Apr. 18, 2002

(54) Connection for corrugated piping sections of metal

(75) Inventors: Dirk Neumaier, Malsch (DE); Rudiger Rieth, Pforzheim (DE); Norbert Thuringer, Tiefenbronn (DE); Axel Muller, Pforzheim (DE)

Correspondence Address: VOLPE AND KOENIG, P.C., SUITE 400, ONE PENN CENTER, 1617 JOHN F. KENNEDY BOULEVARD, PHILADELPHIA, PA, 19103, US

(73) Assignee: Witzenmann GmbH, Pforzheim (DE)

(21) Appl. No.: 09/921,155

(22) Filed: Aug. 2, 2001

(30) Foreign Application Priority Data
Aug. 4, 2000 (DE) 100 38 153.7

(51) Int. Cl. F16L 25/00; F16L 17/00

(52) U.S. Cl. 285/369; 285/903

(57) ABSTRACT

A connection for spirally corrugated piping sections of metal for material sold by length with a continuous cross section. The connection is produced without a separate sleeve in that the ends of two piping sections to be joined with each other are brought into a smooth cylindrical form, and one of the two ends is enlarged in relation to the other cylindrical end. The ends are fitted into each other, and mutual fixation takes place through a glue connection.

### BACKGROUND

The invention relates to a connection for corrugated piping of metal which is manufactured with a continuous cross section as a material sold by the meter.

A typical area of application of corrugated metal piping consists in its use as a reserve pipe or a conduit, which by way of example is laid in sewers and serves for penetration of telecommunications cables. Such an application makes it necessary for piping of great length to be available in order to conduct connection operations on site as little as possible. A required piping length is, for example, 1000 m. Such a great length is, however, as a rule not to be attained in one operation without difficulty. For one, a disturbance-free continuous welding of the metal strip for producing the piping by means of a longitudinal seam over a length of 1000 meters is not always possible, and secondly an available residual length of the metal strip to be used does not always come to the at least necessary 1000 m.

For this reason, there exists a need for being able to join corrugated piping sections of lesser lengths with one another such that first, the unobstructed internal cross section is not reduced in the region of the connection point with at the same time at most minor alteration of the outer diameter, and second, the connection is suited for construction sites despite great load carrying capacity, [and] can thus be produced on site without major expenditure.

### SUMMARY

This object is accomplished in accordance with the invention in that the connection is produced without separate sleeves, in that the ends of two piping sections to be joined with each other are brought into a smooth cylindrical form, in that one of the two ends is enlarged in relation to the other, in that the two ends are fitted into each other, and in that the mutual fixation takes place through a substance-locking or form-locking connection of the ends fitted into each other. Most simply here the connection is produced by a glue. Likewise, however, soldering connections, welding connections (especially orbital welding connections) are also possible in addition to a form lock.

First of all, a basic aspect of the present invention is to be seen in the fact that no separate sleeve must be used which would connect the two ends to be joined with each other. This already essentially contributes to the fact that the outside diameter does not basically change in the region of the connection. The disadvantage in such sleeves, which are widespread in the state of the art, and which are screwed on the spiral corrugation of the piping ends, is also the relatively high installation expense compared with a simple fitting of smooth cylindrical piping ends into each other, as is the case in the object of the present invention. Due to the fact the piping ends are smoothed before being fitted into each other, the entire region of the section height of the piping corrugation is available for fastening the joined ends. Consequently, one must in fact not fall below the unobstructed internal cross section of the corrugated piping sections. Likewise, the outer diameter is also not basically exceeded.

For the previously described use, the connection must have a certain tensile strength, tightness, bursting pressure, resistance to vibration, load bearing capacity, corrosion resistance and electrical conductivity. All these standards can be guaranteed by the present connection lead of the invention where mutual fixation takes place by means of glue. Nonetheless, in order to support the glue in its holding function, it is particularly advantageous if the connection has a circular crimp-like depression in the region of the overlapping smooth cylindrical ends. For on the basis of a mutual, form-locking linkage, the glue is somewhat supported in its function, or else relieved. This crimp-like depression can, for example, be impressed by the use of a roller tool with a defined depth, whereby in particular two crimps are recommended for better load distribution.

Corresponding to the basic demand upon the connection, the internal diameter of the connection must thus be equal to or larger than the unobstructed inner cross section of the two piping sections in order to offer the conduits to be placed in the piping sections sufficient space. In other words, the smooth cylindrical ends are enlarged during the smoothing process in relation to their internal diameter compared to the original unobstructed internal diameter. And also the crimp should not extend further inward than the unobstructed internal diameter of the spirally corrugated piping section.

When enlarging the one piping section end in relation to the other end, an internal diameter merely is to be sought which is slightly greater than the outer diameter of the other end mentioned in order to enable the fitting into each other and to leave sufficient space for the glue to be applied between the two ends fitted into each other.

As regards the installation operation, grinding these smooth cylindrical ends prior to applying the glue is worth recommending to improve the adhesion of the glue. Moreover, for increasing tightness, applying additional glue to the connection from outside after fitting the two ends into each other is recommended, which seals off the remaining seam between the piping section end with the greater diameter and the piping section end with the smaller diameter.

To be sure, the present invention is also suited for annularly corrugated piping sections. The main application will nonetheless relate to the spirally corrugated section tubes described at the beginning (inclined to the right as well as to the left) which are continuously producible in this length, but nevertheless with simpler expenditure.

### BRIEF DESCRIPTION OF THE DRAWINGS

Further features and advantages of the present invention emerge from the further dependent claims and the subsequent description of a preferred embodiment on the basis of the drawing.

In the drawings:

FIG. 1 is a cross-sectional view of a connection in accordance with the present invention.

### DETAILED DESCRIPTION OF THE PREFERRED EMBODIMENT

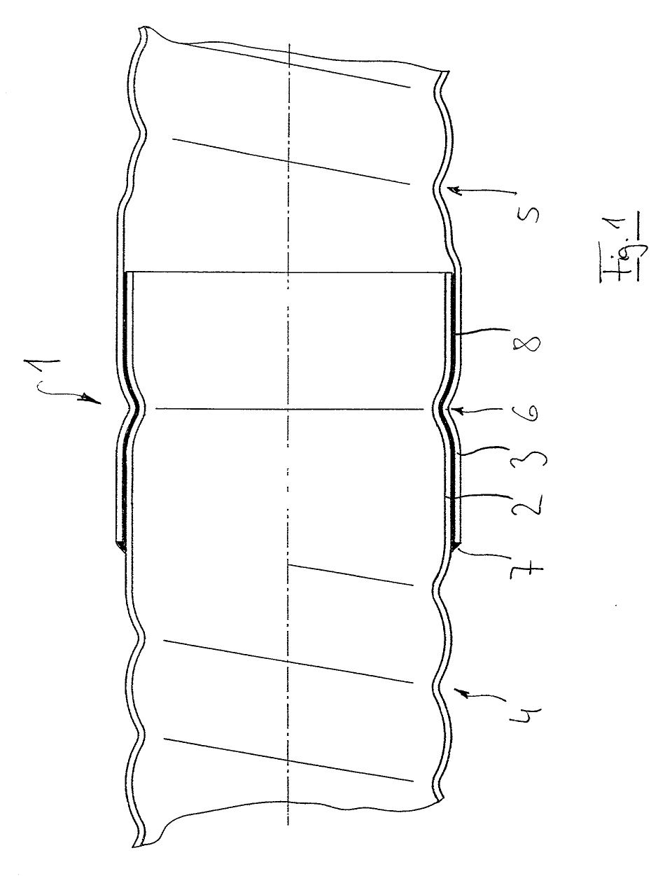

FIG. 1 shows a connection 1 in accordance with the invention. In this connection, two ends 2, 3 of spirally corrugated piping sections 4, 5 are fastened to each other, whereby the two ends to be joined overlap in a smooth cylindrical region. These smooth cylindrical areas are produced from continuous material sold by the meter of piping sections by smoothing, whereby one of the two ends (in the embodiment in FIG. 1, the end 3 of piping 5) is somewhat enlarged in relation to the other end, in order to enable the fitting of the other end (in FIG. 1, of end 2 of piping 4).

Prior to fitting into each other, the smooth cylindrical regions are deburred, roughened, cleaned and coated with glue 8 which produces the adhesion between the two piping sections. Following fitting into each other, a circular crimp-like depression 6 is impressed using a rolling tool in order to fix the two smooth cylindrical regions form-locking on each other as well. Finally, by applying additional glue 7 (which can consist of another material than glue 8), the remaining seam in relation to the interior end 2 is sealed off in the end region of the piping end with a greater cross section.

In summary, through the present invention, a connection lead for corrugated piping sections is made available which is easily producible and which protrudes neither on its exterior nor on its interior, owing to which it for one saves installation space and secondly also does not impair the transfer cross section. Through the connection lead of the invention, two or more corrugated piping sections can be joined to endless lengths. Such a length is not attainable at this time with continuously manufactured piping segments in a contiguous or connectionless operation.

What is claimed is:

1. Connection for corrugated piping sections of metal which are manufactured with a continuous cross section as material sold by length, wherein the connection (1) is produced without separate sleeves and comprises smoothing ends (2, 3) of two piping sections (4, 5) to be joined so they are in a smooth cylindrical form, one (3) of the two ends is enlarged in relation to the other cylindrical end (2), and both ends are fitted into each other, and a mutual fixation takes place through a substance or form-locking connection (8).

2. Connection according to claim 1, wherein the mutual fixation takes place through a glue connection (8).

3. Connection according to claim 1, wherein one or more crimp-like depressions are located in the connection (1) in a region of the overlapping smooth cylindrical ends (2, 3).

4. Connection according to claim 1, wherein an inner cross section of the connection (1) is equal to or greater than an unobstructed inner cross section of the two piping sections (4, 5).

5. Connection according to claim 1, wherein the smooth cylindrical ends (2, 3) of the piping sections (4, 5) have a larger internal diameter than an unobstructed inner diameter of the two piping sections in a corrugated region.

6. Connection according to claim 3, wherein in the region of the crimp-like depression (6), the internal cross section is equal to or greater than an unobstructed cross section of both piping sections (4, 5) in a corrugated region.

7. Connection according to claim 2, wherein the smooth cylindrical ends (2, 3) of the piping sections (4, 5) are roughened prior to applying the glue (8).

8. Connection according to claim 2, wherein the connection (1) is externally sealed with additional glue (7) after fitting the two ends into each other.

9. Connection according to claim 1, wherein the ends (2, 3) of the two piping sections (4, 5) are separated perpendicular to a pipe axis prior to creation of the connection (1).

10. Connection according to claim 1, wherein the piping sections (4, 5) are spirally corrugated.

11. Connection according to claim 1, wherein the piping sections are annularly corrugated.
